(19) United States
(12) Patent Application Publication
(10) Pub. No.: US 2008/0111282 A1
(43) Pub. Date: May 15, 2008

(54) Process for Making Three Dimensional Objects From Dispersions of Polymer Colloidal Particles

(76) Inventors: Baojun Xie, Shaanxi (CN); Jim Smay, Stillwater, OK (US); William Warren, Orlando, FL (US); Robert Parkhill, Orlando, FL (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/558,696

(22) Filed: Nov. 10, 2006

(51) Int. Cl. B29C 35/08

(52) U.S. Cl. 264/401

(57) ABSTRACT

The present invention is a method of freeform fabrication of three-dimensional (3D) objects by depositing polymer colloidal particle based building materials in a predetermined pattern, preferably for biological and/or medical applications. The process of the present invention includes formulating a polymer colloidal dispersion for use as a building material; delivering the dispersion material to a solid freeform fabrication system, and depositing the extruded filaments in a predetermined pattern to form a three-dimensional (3D) object.

### FIELD OF THE INVENTION

The present invention relates generally to the fabrication of three-dimensional (3D) objects from polymer materials. This invention more specifically relates to methods for freeform fabrication of objects by depositing materials layer-wise so as to form 3D objects.

### BACKGROUND OF THE INVENTION

The introduction of solid freeform fabrication (SFF) or rapid prototyping (RP) technologies has signaled the start of a new revolutionary era for products design and manufacturing. As opposed to traditional fabrication methods, SFF technique builds a designed structure directly from a 3D CAD (computer-aided design) model. The additive feature of SFF techniques has proven very useful for producing 3D objects which could not otherwise be manufactured using traditional bulk processing methods.

Current SFF systems can be categorized into three classes, lamination, droplet and extrusion techniques, differentiated by whether a supply material comprising the bulk of the final object is selectively solidified (lithography) or deposited directly onto the previously created surface in a self supporting arrangement as a two dimensional sheets (lamination) as droplets or as individual one dimensional beads or filaments (extrusion).

The Stereolithography (SLA) technique, as described in U.S. Pat. No. 4,575,330, build the polymer parts a layer at a time by tracing a shape at the surface of a bath of a liquid medium in a bath using prescribed stimulation. A supporting platform then drops by one layer of thickness, a further layer of monomer is swept across the newly solid surface and the process repeated. The liquid medium is typically a photo-polymerizable polymer and the prescribed stimulation is typically visible or ultraviolet radiation. In this technology, the feedstock is limited to photo curable material.

Selective Laser Sintering (SLS), as described in U.S. Pat. No. 4,863,538, is another stereolithography technology. It produces parts by scanning polymer powder with a computer-directed heat laser. The powder is melted to form a layer at a time. The feature size of SLS is dependent on the powder size of the available stock material, which is normally larger than 50 microns.

Three Dimensional Printing (3DP) is described in U.S. Pat. No. 5,204,055. The process starts by depositing compresses a layer of powder object material at the top of a fabrication chamber by a roller. The jetting head subsequently deposits a liquid adhesive in a two dimensional pattern onto the layer of the powder which becomes bonded in the areas where the adhesive is deposited, to form layers of the object. Similar to SLS, the feature size of SLS is also dependent on the powder size. In addition, 3DP generally relies heavily on the use of organic solvents as binders to dissolve the polymer powders in the printed regions.

Laminated Object Manufacturing (LOW) referenced by U.S. Pat. Nos. 4,752,352 and 5,015,312 involve the formation of 3D objects by using a laser to cut layers of a glue-backed paper material, which are bonded together during the process to form the solid model. Normally, the paper is the sole source of the materials to form the object.

Fused Deposition Manufacturing (FDM) is described in U.S. Pat. No. 5,121,329. To form a 3D object, a plastic filament is fed in to an extrusion nozzle and the nozzle is heated to melt the plastic then deposits a thin bead of extruded plastic to form each layer. The plastic hardens immediately after being squirted from the nozzle and bonds to the layer below. During the FDM process, the material is subject to intense heat, which may yield unfavorable results on material properties.

Multi Jet Modeling (MJM), described in PCT Publication No. WO 97 11835 and WO 97-11837, uses an apparatus similar to an inkjet printer head which selectively deposits droplets of materials from multiple inkjet orifices to form layers. The deposition material is usually a special polymer with a very low melting point, and it hardens as soon as it leaves the nozzle. There are also nozzle-based systems that deposit liquid polymer that is then cured, layer-by-layer, using an ultraviolet light.

Because of the flexibility and customized manufacturing capabilities, SFF has been employed for diverse biological and medical applications ranging from the production of surgical planning models to custom-made prosthetic implants and other areas of medical sciences including anthropology, palaeontology and medical forensics. In theses applications, the configuration of the objects can be automatically obtained by scanning the desired area of the patient through integration modern image modality with SFF to accomplish high throughput production with minimal manpower requirements.

To date, SFF technique has been limited to this traditional “bone and tooth” repair market and been unsuitable for broader biological and/or medical applications. This is because biological and medical applications impose a great challenge for the current SFF techniques because of the requirements for the bio-functionality of the formed objects. For instance, in order to fabricate a tissue-engineering scaffold that guides the cells to grow into the correct geometric structure, the material used in the SFF methods ought to be biocompatible and work in coordination with the rest of the body. In addition, it should be biodegradable so as to be adsorbed but yet adjustable so as to match the rate of tissue regeneration. Neither the materials nor its degradation products should provoke inflammation or toxicity. Some possibilities are offered by biodegradable polymers such as polylactic acid-co-glycolic acid (PLGA) and poly (β-caprolactone) (PCL), alginate, chitosan. However, synthetic polymers such as PLGA must be dissolved in organic solvents in the process, which may leave toxic residue in/on the formed parts. Aqueous and room temperature processing conditions, although present a benign environment for incorporation of sensitive biomolecules (e.g. blood vessel promotion factors), are limited to water-soluble polymers or hydrogels, which are normally weak physically and lack molecular design flexibility. Some of them require the reaction between dispensing material and dispensing medium in most cases.

Thus, unfortunately, all of the present SFF techniques are subject to containing inherent difficulties and limitations in biological three-dimensional object creation processes. In summary, the key disadvantages associated with one or more of the current systems are (1) limited to photo curable resins, (2) toxic deposition material, (3) exposure to toxic organic solvent, (4) require extreme heating and elevated temperature, (5) require complexion formation ability of deposition material, (6) weak physical strength and poor structural stability if aqueous polymers are used. Therefore, to address the need for broader materials selections and mild processing conditions, new material formulation scheme and specialized SFF processes have to be developed and are the object of the present invention.

### OBJECTS OF THE INVENTION

It is, therefore, an object of this invention to provide a new and superior method for 3D manufacturing of objects from polymer materials in a biologically benign process (e.g. aqueous, low temperature). A further object is to provide a polymer colloidal dispersion based building material, unlike other materials that are normally utilized in solution, film, filament, laminate, or powder forms in prior art techniques, for the deposition process. Still another objective is to provide a drug incorporation method for temporally and geospatially controlled release of biomolecules and maintaining their bioactivities. Other and further objectives will be hereinafter described and more particularly delineated in the appended claims.

### SUMMARY OF THE INVENTION

The present invention is a method of freeform fabrication of three-dimensional (3D) objects by depositing polymer colloidal particle based building materials in a predetermined pattern, preferably for biological and/or medical applications. The process of the present invention includes formulating a polymer colloidal dispersion for use as a building material; delivering the dispersion material to a solid freeform fabrication system, and depositing the extruded filaments in a predetermined pattern to form a three-dimensional (3D) object.

The present process also includes the formulation of the building material to include optimal viscosity and rheology and the optional incorporation of biomolecules in the building material, either in their original form, or incapsulated in nano/mircroparticles. The extruded filaments of the building material may be produced an extrusion nozzle and deposited on a substrate moving in relation to the nozzle. The extruded filaments are deposited on the substrate layer-by-layer to assemble the 3D object.

The 3D objects produced according to the process of the present invention may be bio-functional objects, such as drug delivery systems, medical devices, pharmaceutical dosage forms, tissue engineering scaffolds, or other articles which may require the capability of temporally and spatially controlled release of bioactive molecules. The resulting 3D polymeric objects are particularly useful as tissue engineering scaffolds, prosthetic implants, and multi-port drug delivery devices. It is even contemplated that 3D objects may be produced according to the present invention to form porous tissue-engineering scaffolds for the production of artificial organs.

The building material of the present invention is composed of polymer colloidal particles and a polymer binder to form a polymer colloidal suspension. Optionally, biomolecules may be admixed into the suspension. As used herein, the term biomolecules shall include any chemical compound that occurs in living organisms. The solid loading of the building material of the present invention is at least 30% and preferably more than 55% to obtain desirable viscoelastic properties. The polymer binder is preferably able to facilitate the colloidal system to form colloidal gels through the formation of reversible physical crosslinking with the particle colloidal particles or itself.

The biomolecule loaded 3D objects produced according to the present invention can be made to exhibit short term or long term release kinetics, thereby providing either rapid or sustained release of biomolecules. The process for forming three-dimensional objects of the present invention is aqueous, mild, and does not adversely affect the biological activity of the biomolecules present therein. Therefore, if desired, the biomolecules released from the formed objects retain their natural bioactivity.

### BRIEF DESCRIPTION OF THE DRAWINGS

FIG. 1 is a flow chart depicting the process of the present invention.

FIG. 2 is a flow chart depicting the preferred embodiment of the process of the present invention.

FIG. 3 is a schematic representation of a release medium for a bio-macromolecule created according to the process of the present invention.

FIG. 4 is an isometric representation of an apparatus for the robotic deposition of building material employing the process of the present invention used to make three-dimensional objects.

### DETAILED DESCRIPTION OF THE PREFERRED EMBODIMENTS

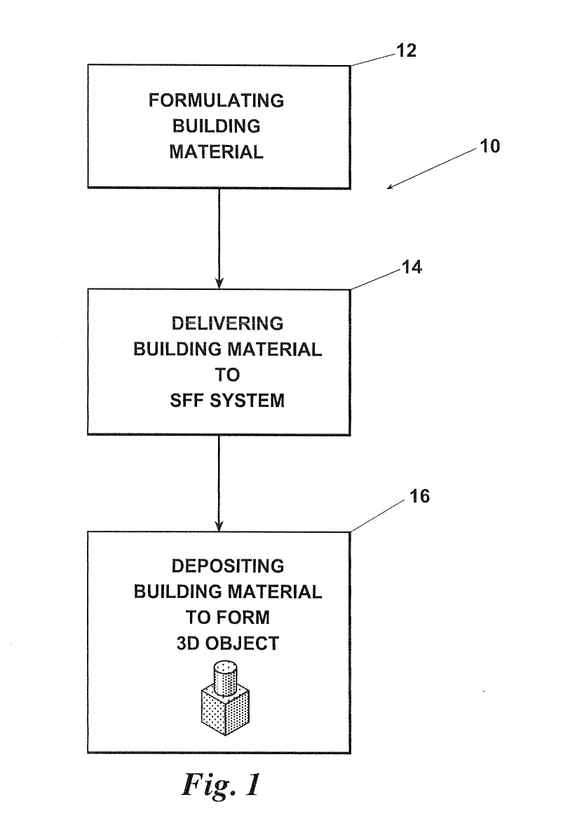

The present invention is directed to a solid freeform fabrication (SFF) method for fabricating 3D objects through multiple subsequent deposition of layers (layer-by-layer) of polymer colloidal particle based building materials. This process employs an SFF apparatus and a building material used to produce 3D objects. With reference to FIG. 1, the process 10 of the present invention includes steps of formulating the building material 12, delivering the building material to a solid freeform fabrication (SFF) system 14, and depositing the building material via the SFF system to form a three dimensional (3D) object 16.

### Formulation of the Building Material

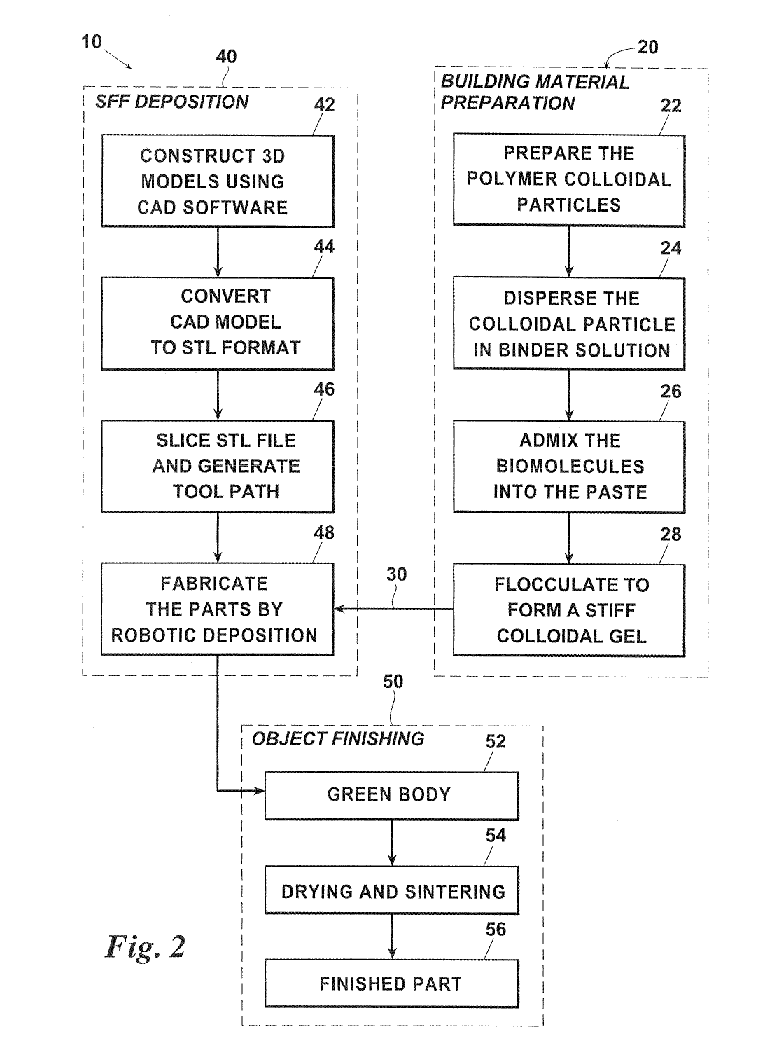

With reference to FIG. 2, formulation of the building material 20 shall be described. In the present invention, the building material is mainly composed of polymer colloidal particles. The use of polymer colloidal particles as building material are particularly suitable for designing 3D objects with both mechanical strength and bio-functionality. The formulation of building materials is essentially aqueous and free of harmful reagents such that it diminishes problems associated with organic solvents during the deposition of water-insoluble polymers. It is contemplated that any water-insoluble polymers could be processed into colloidal particles so as to be used for deposition according to the present invention. In fact, the use of water-insoluble particles is particularly suitable for the present invention.

Additionally, or in the alternative, the material formulation of building material can be designed in a modular concept: The colloidal particles prepared from synthetic polymers with the most desirable mechanical and biodegradable properties can be suspended in an aqueous solution to provide structural support. Biopolymers, such as alginate and chitosan, dissolved in aqueous solution may be added in order to modify the surface chemistry and control the viscoelastic properties of the building material. Therefore, it is contemplated in the present invention becomes possible to combine the merits of both naturally derived polymers (hydrophilic in most cases) and synthetic polymers (normally hydrophobic).

To formulate the building material of the present invention and shown at FIG. 2, the preferred polymer particle materials are required to be processed into the colloidal state. The colloidal particles can be obtained from emulsion/dispersion polymerization or physical emulsification processes if the polymerization cannot yield the particle directly. The particle size is limited by some practical considerations. First, the particles must be small enough to flow through a deposition (extrusion) nozzle. The nozzle diameter to particle size ratio (D/a) is a convenient term for this purpose. Preferably, D/a should be more than 150 based on the average particle size or D/a more than 20 based on the largest particles. The second practical limit of particle size is that the concentration must be sufficiently high so that drying stresses do not damage the structure. This becomes difficult for nanoparticles because of the excluded volume of the electrical double layer or the steric layer required to achieve high solids loadings. Once the polymer colloidal particles are prepared, they are next dispersed in a binder solution. This is shown in step 24 of FIG. 2.

In a highly preferred embodiment as depicted in FIG. 2, the building material is formulated into a colloidal gel by introducing a gel forming polymer binder. Colloidal gels are a class of materials which are comprised of a percolating network of attractive colloidal particles that acts as a solid sponge, imprisoning the liquid within its structure. Colloidal gels possess flowing behaviors such as high viscosity as well as thioxtropic and pseudoplastic rheology, which make them ideally suited for assembling complex 3D objects. This rheology can be best described by the Hershel-Bulkley model:

τ=τ_{y}+K\dot{γ}ⁿ

During SFF deposition, the colloidal gel based building material will experience high shear conditions while flowing through the orifice. The colloidal gels initiated by physical association of the particle are not strong enough to keep the network intact in this condition and the colloidal particulate network becomes temporarily disrupted to exhibit a shear thinning rheology. This facilitates the smooth flow of the building material through the deposition nozzle. However, immediately after the building material leaves the orifice, the building material returns to a quiescent state and undergoes a shear rate near zero. The colloidal network is re-established rapidly and the material returns to flow resistant gels and solidify in place, having enough strength to support later deposited materials.

The polymer binder is critical for the colloidal gel formation and, preferably, two mechanisms can be utilized to induce the sol-gel transition in a colloidal suspension to form the colloidal gel. One is to collapse the extended binder (can be regarded as stabilizer) layers absorbed on the particle surface. The other is to form the inter-particle bridging by cross-linking of absorbed binder on the particle surface. Thus, the binder should have the ability to cross-link by itself or with other substances under environment changes, such as pH and temperature. It should be cognizant that the crosslinking must be reversible so that the particle network in the colloidal gel can be broken under high shear and re-establish after removal of the shear. Therefore, crosslinking of the polymer binder should be formed through non-covalent bonding physical forces, such as Coulombic attraction, van der Waals, hydrophobic bonding, and the like. The examples of these gelling polymers include thermo responsive polymers (agar, agarose, kappa carragreenan and pluronic), pH dependent polymers (polyacrylic acid) and ionic interaction pairs (Alginate+calcium ion, alginate+chitosan, polyacrylic acid+Polyethyleneimine).

### Biomolecule Incorporation

The polymer fabrication method in the present invention is biological in nature because it simply relies on the rheological properties of the colloidal suspension and the ability of the latex particles to coalesce upon drying with the application of minimal heat. There are no extensive heating, organic solvent, chemical reaction or ultraviolet ray involved throughout the whole deposition process. Therefore, pharmaceuticals and bioactive molecules can be easily integrated into the building material for fabrication into bio-functional polymer objects formed in a biologically benign environment and controlled released for pharmaceutical and biological applications. FIG. 2 depicts admixture of biomolecules into the building material at 26.

When it is desirable for the building material of the process of the present invention to incorporate small pharmaceutical molecules (biomolecules), the building material is preferably fully coalescented into a continuous solid where drug content is scattered in the polymer matrix. The mechanism for the controlled release relies on formation of the diffusion retardant polymer membrane and the drug released through polymer chains. Alternatively, a bio-erodable matrix material may be used such that the drug release profile is tied to degradation of the scaffold. It is thereby contemplated to fabricate pills with precise and complex time-release characteristics or that dissolve almost instantly. Medications can be made more effective in this way, and drug companies may be able to realize stronger revenue streams from older compounds with expired patents by providing them in novel and beneficial dosage forms. Transdermal therapeutic systems and topical drug patches account for another application for this type of controlled release.

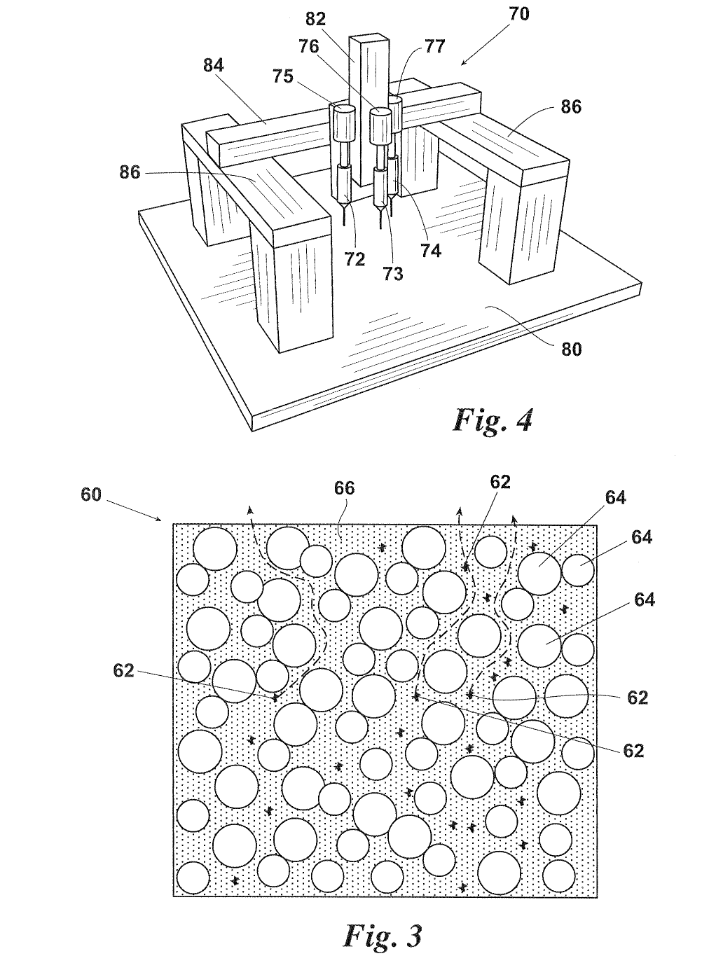

When it is desirable for the building material of the process of the present invention to incorporate bio-macromolecules such as protein and DNA, the preferred embodiment of the present invention is to arrest the sintering of the prepared objects before the full coalescence because the bio-macromolecules are considered too large to slowly release from the hydrophobic polymer matrix by Fickan diffusion mechanism. However, in this case, the void space in the interstices of the colloidal particles allows bio-macromolecules to disperse throughout the polymer colloidal particle network. The pores in the matrix of the produced 3D object are filled with aqueous polymer binders, which are both the carrier and transport medium for the bio-macromolecules. Upon contact with a release medium, swelling hydrogel and water filled cavities/channels are created and the bio-macromolecule transport occurs in theses domains. The bio-macromolecules then diffuse from the voids inside the whole matrix and the polymer objects can be utilized as controlled drug delivery vehicles, as shown in FIG. 3. FIG. 3 depicts a schematic of protein release from a scaffold rod release medium 60. As shown, protein collectively 60 is admitted in a suspension of acrylic latex particles 62 in a pluromic hyrdrogel 64. The protein diffusion behaviors are determined by various factors, e.g. protein diffusion coefficient, protein loading, protein distribution in polymer binder, along with the characteristics of the void structures (tortuosity and connectivity).

In one of the embodiments of present invention, bio-macromolecules are admixed with building materials directly and then deposited to the polymer part with predefined shape and pore structure. In this embodiment, the bio-macromolecule content is scattered in a porous matrix formed by amalgamated particle networks, where the drug release is osmotically controlled. In this approach, biomolecules with building materials normally result in very fast protein release.

In another alternative embodiment, colloidal particle-drug laden nanoparticle composite systems are created through the dispersion of biomolecule encapsulated nanoparticles in the building material used to fabricate the objects. In this case, the duration of bio-macromolecule release is significantly extended. Also the mixing of nanoparticles normally has no detrimental effect on material rheology.

Preferably, a post-processing procedure should be implemented to stiffen the resulting polymer objects and increase their physical strength. This procedure is identified at step 28 of FIG. 2. If highly sensitive biomolecules such as protein and DNA is incorporated, the building materials are required to be solidified through particle coalescence, or flocculate, at low temperature, preferably below 37 degree C. As can be expected, the strength of the formed parts is proportional to the particle coalescence degree. One embodiment of the invention is to select the polymer with low minimum film formation temperature (MFT), which is a characteristic temperature below which the colloidal particles can no longer form a film. Other alternative embodiments include introducing plasticizer or mixing with polymer colloidal particles with low MET and preferably compatible with the main colloidal particles. Plasticizers which are particularly suitable for this purpose include glyceryl diacetate (GDA), glyceryl triacetate (GTA), triethyl citrate (TEC), acetyltriethyl citrate (ATEC) and dibutyl sebacate (DBS) and polyethylene glycol (PEG).

### EXAMPLES

The following building material formulation examples are for illustration only and are not intend to limit the scope of the invention.

### Example 1

The polymer acrylic latex with average particle size of 1 micron and MFT of 10 degree C. was vigorously agitated prior to experiment at ion for 10 min. followed by sonication for 5 min. A dilute sodium alginate solution was prepared by dissolving sodium alginate in DI water to concentration. The dilute sodium alginate solution (0.5˜2 wt %) was added to the latex suspension and vortexed for 10 min. The suspension was then magnetic stirred for 2 hours. Finally, the suspension was concentrated into desired solid content (Φₗₐₜₑₓ) by centrifuge. The process was repeated three times to ensure the latex was restabilized by alginate. The calculated amount of sodium alginate was then added into concentrated latex polymer and the suspension was then vigorously vortexed for 15 min. Finally, a building material was formed with solid loading ranging from 40˜55 wt % and sodium alginate concentration ranging from 2˜5 wt %.

### Example 2

A CaCO₃ suspension was added into a concentrated polymer latex prepared according to the method described in Example 1, mixed and vortexed for 15 min. A fresh aqueous GDL solution was then added to the suspension and vortexed for 15 min. to initiate gelation. Finally, a building material was formed with solid loading ranging from 40˜55 wt % and sodium alginate concentration ranging from 0.2˜1 wt %.

### Example 3

The calculated amount of Pluronic F127 was first dissolved in distilled water at a temperature of 4 degree C. Next, an appropriate volume fraction of acrylic latex powder was added to the solution and a stable suspension (φ=0.47˜0.62) was formed. The suspension was then vigorously homogenized for 5 min. followed by processing with a three-roller mill for 5 minutes. The suspension was brought to room temperature and particle gelation was induced. Finally, a building material was formed with solid loading ranging from 40˜65 wt % and pluronic concentration ranging from 6˜10 wt %.

### Example 4

Calculated amounts of BSA were admixed with building material prepared in Example 3 using a custom-made syringe mixer. Finally, a building material was formed with BSA loading of 0.5 wt %.

### Example 5

Chitosan with various molecular weight (Mw) was dissolved with BSA in 1% (W/W) acetic aqueous solution at concentration of 1 mg/ml and 0.5 mg/ml respectively. Then 2 ml of 1.0 mg/ml TPP solution was added to 5 ml of the Chitosan-BSA solution. Nanoparticles were formed spontaneously under magnetic stirring at room temperature due to ionotropic gelation between chitosan and TPP. The suspension was kept in magnetic stirring for 30 min. and the nanoparticles were collected by ultracentrifiguration at 20000×g.

Calculated amount of BSA encapsulated particles were admixed with building material prepared in Example 3 using a custom-made syringe mixer. Finally, a building material was formed with BSA loading of 0.5 wt %.

### Building Material Deposition

The process of the present invention employs an extrusion based SFF apparatus and a building material used to produce 3D objects. In a more detailed preferred embodiment of the present process as shown in FIG. 2, and step 30, the building material is delivered to a SFF system for further processing in to 3D objects. According to this process, the building material is extruded through a fine nozzle and deposited on a substrate moving relatively to the nozzle or on the top surface of the preceding layers. After deposition, the building materials undergo sufficient solidification to support the successive layers and build up the 3D constructs layer-by-layer

The flow chart of FIG. 2 shows the underlying process of the invention and its various hereinafter described embodiments, including formulation of the building material, robotic deposition of the structure and post-processing. In the preferred embodiment, the robotic deposition process includes the following steps: (1) a CAD model of the design is created at 42; (2) the CAD model is converted to a stereolithography (STL) format at 46; (3) the STL file is then sliced into thin cross-sectional layers and a tool path is generated at 48; (4) the SFF technique is then actuated at 48 to construct the object one layer atop another. Finally, the object is cleaned and finished. Object finishing at 50 may also include drying and sintering at 54 to produce a finished part at 56.

This description is made according to the purpose as it is understood that some additional steps may be added to the process. For instance, to form the implant that mimics the target tissue, the CAD model can be obtained by reverse engineering technique from digitized anatomical information.

In accordance with embodiments of the subject process, a preferred apparatus for carrying out the freeforming of building material is illustrated in FIG. 4. This deposition apparatus comprises three axes of motion control (X, Y, and Z-axis) which are provided by the gantry system. A material delivery assembly 70 comprising three syringes 72, 74, and 76 as building material reservoirs is affixed on the Z-axis motion stage 82. The Z-axis motion stage assembly is mounted on a moving X-Y gantry 84 and 86 to enable controlled motion of the mounted syringes in three dimensions. Three extra linear actuators 75, 76, 77 are part of the material delivery system and are used to depress the respective plungers of syringes 72, 73, and 74 vertically at a rate proportional to the extrusion rate. The building material housed in reservoirs (not shown) is then deposited through a cylindrical nozzle (diameter 50˜500 μm) and the cylindrical rod of extruded building material exiting the nozzle lies parallel to the table 80 as the x-y gantry system moves. Accordingly, 6-axis motion is independently controlled by a computer-aided direct-write program that allows for the design and assembly of complex multi-material 3-D architectures with a layer-by-layer deposition scheme.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A process for making a three dimensional object, comprising:
formulating a polymer colloidal dispersion for use as a building material;
delivering said building material to a solid free form fabrication system;
depositing said building material in a predetermined pattern to form the three dimensional object.

2. The process of claim 1 including additional steps, comprising:
creating a CAD model of a design for the three dimensional object;
converting the CAD model to a stereolithographic format file;
delivering said stereolithographic format file to said solid free form fabrication system.

3. The process of claim 2 further including the step of creating a tool path for said solid free form fabrication system by slicing the stereolithographic format file into thin cross sectional layers of the three dimensional object.

4. The process of claim 1 wherein said polymer colloidal dispersion is created according to a method comprising:
obtaining a polymer acrylic latex;
agitating said polymer acrylic latex to form a polymer acrylic latex suspension;
adding a sodium alginate solution to said polymer acrylic latex suspension;
agitating said suspension to form a polymer colloidal dispersion.

5. The process of claim 4 wherein said polymer colloidal dispersion is formed with a solid loading range from 40 to 55 wt. % and a sodium alginate concentration ranging from 0.2 to 1 wt. %.

6. The process of claim 1 wherein said polymer colloidal dispersion includes an admixture of biomolecules.

7. The process of claim 6 wherein said biomolecules are small pharmaceutical molecules.

8. The process of claim 6 wherein said biomolecules are large molecules.

9. The process of claim 8 wherein said large molecules are selected from a group consisting of protein and DNA.

10. A process for making three dimensional objects, comprising:
formulating a polymer colloidal dispersion including an admixture of biomolecules for use as a building material;
delivering said building material to a solid free form fabrication system;
depositing said building material in a predetermined pattern to form the three dimensional object.

11. The process of claim 10 including additional steps, comprising:
creating a CAD model of a design for the three dimensional object;
converting the CAD model to a stereolithographic format file;
delivering said stereolithographic format file to said solid free form fabrication system.

12. The process of claim 11 further including the step of creating a tool path for said solid free form fabrication system by slicing the stereolithographic format file into thin cross sectional layers of the three dimensional object.

13. The process of claim 10 wherein said biomolecules are small pharmaceutical molecules.

14. The process of claim 10 wherein said biomolecules are large molecules.

15. The process of claim 14 wherein said large molecules are selected from a group consisting of protein and DNA.
